(19) United States
(12) Patent Application Publication
(10) Pub. No.: US 2022/0259353 A1
(43) Pub. Date: Aug. 18, 2022

(54) THERMORESPONSIVE COPOLYMER, NANOFIBER STRUCTURE COMPRISING THE SAME, AND METHOD FOR PREPARING NANOFIBER STRUCTURE

(71) Applicant: Gwangju Institute of Science and Technology, Gwangju (KR)

(72) Inventors: Hee Chul CHOI, Gwangju (KR); So Young KIM, Gwangju (KR)

(21) Appl. No.: 17/631,318

(22) PCT Filed: Oct. 28, 2020
(86) PCT No.: PCT/KR2020/014809

§ 371 Date: Jan. 28, 2022

(30) Foreign Application Priority Data
Oct. 28, 2019 (KR) 10-2019-0134726

(51) Int. Cl. C08F 226/06; C08F 220/06; C08J 3/24

(52) U.S. Cl. CPC C08F 226/06; C08J 3/24; C08F 220/06

(57) ABSTRACT

The present invention relates to a thermoresponsive copolymer, a nanofiber structure comprising the same, and a method for preparing a nanofiber structure, more specifically relates to a thermoresponsive copolymer, which can be applied to various industrial fields since of which the contraction or expansion can be controlled based on a specific lower critical solution temperature and the mechanical strength is a certain level or higher as well as the core-shell structure exhibiting improved hydrophilicity can increase the amount of water absorbed/desorbed, a nanofiber structure comprising the same, and a method for preparing a nanofiber structure.

### TECHNICAL FIELD

The present invention relates to a thermoresponsive copolymer, a nanofiber structure comprising the same, and a method for preparing a nanofiber structure, more specifically relates to a thermoresponsive copolymer, which can be applied to various industrial fields since of which the contraction or expansion of polymer can be controlled based on a specific lower critical solution temperature and the mechanical strength is a certain level or higher as well as the core-shell structure exhibiting improved hydrophilicity can increase the amount of water absorbed/desorbed, a nanofiber structure comprising the same, and a method for preparing a nanofiber structure.

### BACKGROUND ART

Hitherto, silica gel, zeolite, and activated alumina have been commercialized as water absorption/desorption materials, but there has been a limit in terms of economic feasibility since a high temperature of 50° C. or higher is required for complete desorption after dehumidification. Hence, the development of materials that exhibit excellent pore characteristics and require low preparing cost is being actively carried out, and recently, research on water absorption/desorption using polymers that exhibit thermoresponsivity has increased. As representative thermoresponsive polymers, there are PNIPAM [poly(N-isopropylacrylamide)], PVCL [poly(N-vinylcaprolactam)] and the like, but these polymers do not absorb/desorb a large amount of water and have a weak mechanical strength and it is thus difficult to apply these polymers to industrial sites.

### CITATION LIST

### Patent Literature

### [Patent Literature 1]

Korean Patent Publication No. 10-2019-0084840 (published date: Jul. 17, 2019)

### SUMMARY OF INVENTION

### Technical Problem

Accordingly, the present invention has been devised to solve the above-mentioned problems, and an object of the present invention is to provide a thermoresponsive copolymer, which can be applied to various industrial fields since it is obtained by copolymerizing a N-vinylcaprolactam monomer and an acrylic acid monomer and thus not only absorbs or desorbs a large amount of water through contraction or expansion at a certain lower critical solution temperature but also has a high mechanical strength through crosslinking between nanofibers, a nanofiber structure comprising the same, and a method for preparing a nanofiber structure.

### Solution to Problem

To this end, the thermoresponsive copolymer according to the present invention comprises a repeating unit derived from a N-vinylcaprolactam monomer and a repeating unit derived from an acrylic acid monomer.

The copolymer may comprise the repeating unit derived from a N-vinylcaprolactam monomer at 80 to 98 mol % and the repeating unit derived from an acrylic acid monomer at 2 to 20 mol %.

In the nanofiber structure according to the present invention, nanofibers comprising the copolymer are crosslinked.

The nanofiber may have a core-shell structure, the core of the nanofiber may contain a hydrophilic polymer, and the shell of the nanofiber may contain the copolymer.

The hydrophilic polymer may be one or more selected from the group consisting of polyacrylonitrile, cellulose acetate, polyvinyl chloride, vinyl chloride-vinyl acetate copolymer and polyamide.

The nanofiber structure may have a lower critical solution temperature (LCST) of 33° C. to 38° C.

The nanofiber structure may exhibit a water absorbing property at a temperature less than the LCST and a water desorbing property at a temperature more than the LCST.

The method for preparing a nanofiber structure according to the present invention comprises preparing a copolymer by copolymerizing a N-vinylcaprolactam monomer and an acrylic acid monomer; preparing nanofibers by electrospinning a copolymer spinning solution prepared by dissolving the prepared copolymer in an organic solvent; and crosslinking the prepared nanofibers through a heat treatment.

The organic solvent may be a protic solvent, for example, ethanol, methanol, isopropyl alcohol or water.

In the step of preparing nanofibers, a hydrophilic polymer solution and the copolymer spinning solution may be injected into an inner nozzle and an outer nozzle of a co-axial heterogeneous electrospinning device, respectively, and then electrospun to prepare nanofibers having a core-shell structure.

### Advantageous Effects of Invention

The effects according to the present invention are as follows.

1. The lower critical solution temperature of the copolymer according to the present invention can be controlled depending on the contents of a N-vinylcaprolactam monomer exhibiting thermoresponsivity and an acrylic acid monomer, the temperature required for reuse of the copolymer is lower than those of conventional water absorbents, so the economic efficiency of the copolymer is excellent.

2. The nanofiber structure according to the present invention can secure a certain mechanical strength since crosslinks between nanofibers are formed during a heat treatment because of the acrylic acid, and thus the nanofiber structure more hardly dissolves in water compared to conventional thermoresponsive polymers and has an effect of smoothing the movement of water molecules.

3. The nanofiber structure according to the present invention may have a core-shell structure, and thus has an effect of further increasing the amount of water absorbed because of the core formed of a hydrophilic polymer.

4. The nanofiber structure according to the present invention has a high porosity and a high absorption rate, and can be thus applied to separation materials, drug delivery, energy storage, packaging, adsorption heat pumps, heat exchangers and the like.

### BRIEF DESCRIPTION OF DRAWINGS

FIG. 1 is a conceptual diagram illustrating a water absorption/desorption process of a nanofiber structure according to an embodiment of the present invention.

FIG. 2 is a graph illustrating changes in the lower critical solution temperature of the nanofibers according to Examples and Comparative Examples depending on the acrylic acid content.

FIG. 3 is a graph illustrating changes in the water contact angle of the nanofibers according to Examples and Comparative Examples depending on time.

FIG. 4 is a graph illustrating changes in the water contact angle of the nanofibers according to Examples and Comparative Examples depending on temperature.

FIG. 5 is a graph illustrating the amount of water absorbed by the nanofibers according to Examples and Comparative Examples depending on temperature.

FIG. 6 is an enlarged photograph and a graph illustrating the shell thickness depending on spinning and ejection speed of a shell solution at the time of preparation of the nanofiber structure according to the present invention.

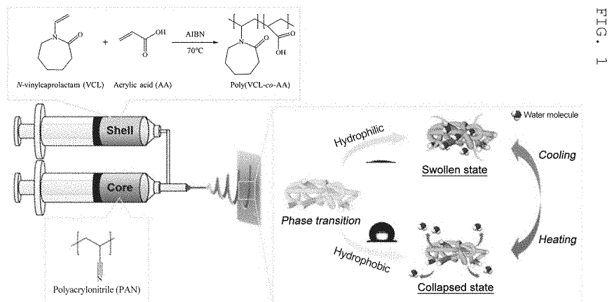

### DESCRIPTION OF EMBODIMENTS

In order to fully understand the present invention, the operational advantages of the present invention and the objects achieved by the practice of the present invention, reference should be made to the accompanying drawings illustrating preferred embodiments of the present invention and the contents described in the accompanying drawings.

In describing preferred embodiments of the present invention, well-known techniques or repetitive descriptions that may unnecessarily obscure the gist of the present invention will be reduced or omitted.

N-vinylcaprolactam (hereinafter ‘VCL’) polymer exhibits thermoresponsivity, and undergoes hydrophilic/hydrophobic phase transition at a specific lower critical solution temperature (LCST). However, the nanofiber structure easily collapses when a nanofiber is prepared by electrospinning the VCL polymer since the nanofiber is vulnerable to water.

Hence, the present invention has an advantage that it is possible to secure a certain mechanical strength at the time of nanofiber preparation as well as to increase the hydrophilicity and the water absorption rate since the VCL monomer is copolymerized with an acrylic acid monomer in the present invention.

The copolymer according to the present invention may be prepared as in [Scheme 1] below.

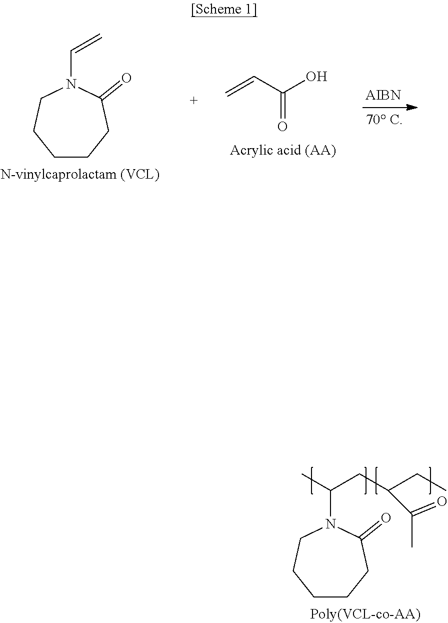

The copolymer according to the present invention is prepared by a free radical reaction of the VCL monomer in an organic solvent using an initiator (2,2′-azobisisobutyronitrile (AIBN), or the like). In this case, a higher reaction yield may be obtained by using a polar protic solvent as the organic solvent. Representative examples of the organic solvent include ethanol, water, methanol, and isopropyl alcohol.

The copolymer according to the present invention may comprise the repeating unit derived from a N-vinylcaprolactam monomer at 80 to 98 mol % and the repeating unit derived from an acrylic acid monomer at 2 to 20 mol %.

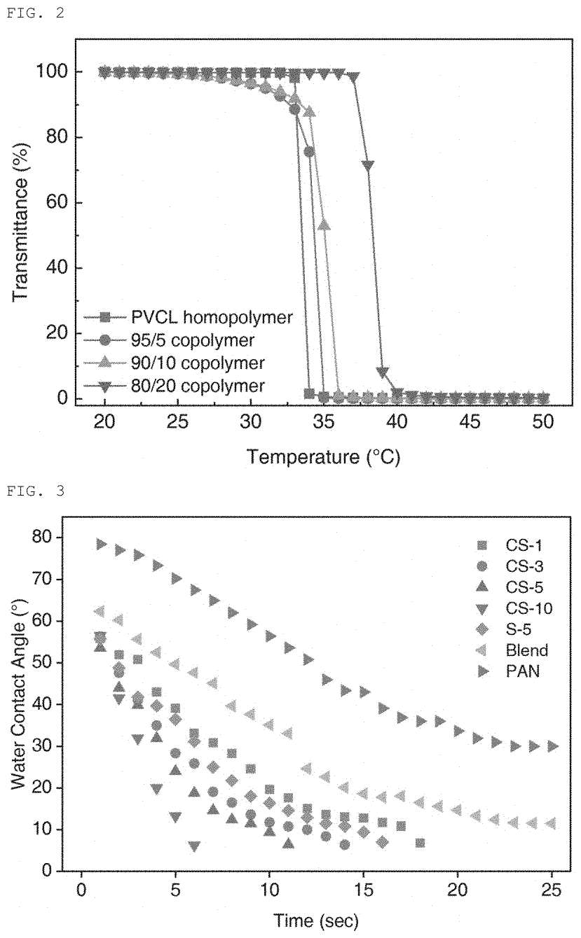

The lower critical solution temperature (LCST) of the prepared copolymer varies depending on the acrylic acid content, and the LCST increases as the content of acrylic acid increases as can be seen from FIG. 2.

Next, a nanofiber structure in which nanofibers comprising the copolymer according to the present invention are crosslinked will be described.

The nanofiber structure according to the present invention is prepared by electrospinning a spinning solution in which the copolymer is dissolved in an organic solvent. Nanofibers having a single structure may be prepared by injecting only the copolymer spinning solution into a nozzle during spinning for preparation, but it is more preferable in terms of the amount of water absorbed to prepare nanofibers having a core-shell structure by injecting a hydrophilic polymer spinning solution and the copolymer spinning solution into the inner and outer nozzles of a co-axial heterogeneous electrospinning device, respectively, and then co-axial electrospinning the spinning solutions.

The preparing process of the nanofiber having a single structure may include a process of preparing a copolymer by copolymerizing a N-vinylcaprolactam monomer and an acrylic acid monomer, a process of preparing nanofibers by electrospinning a copolymer spinning solution prepared by dissolving the prepared copolymer in an organic solvent, and finally a process of crosslinking the prepared nanofibers through a heat treatment.

In the case of a nanofiber structure having a core-shell structure, a hydrophilic polymer solution and the copolymer spinning solution are injected into the inner and outer nozzles of a co-axial heterogeneous electrospinning device, respectively, and then co-axially electrospun at the time of electrospinning.

In the co-axial electrospinning process, spinning of the core spinning solution and spinning of the shell spinning solution are performed at the same voltage and at the same spinning distance. At the time of electrospinning, the voltage is preferably about 12 to 20 kV, but when the voltage is less than 12 kV, the voltage is not sufficient and there may be a problem that the polymer spinning is not properly performed or the core-shell structure is not properly formed and a single fiber is prepared or nanofibers having a uniform size are not prepared.

In the co-axial electrospinning process, the characteristics of the core spinning solution and shell spinning solution are important, and thus in a case where the solvents of the core and shell spinning solutions have a large difference in volatility, a case where immiscible solvents (water-N,N-dimethylfomamide, and the like) are used, or a case where there is a large difference in viscosity between the spinning solutions when the two spinning solutions are ejected from the double co-axial nozzles, there may be a problem that nanofibers fail to form a core-shell structure or nozzle clogging occurs.

The core polymer of the nanofiber according to the present invention is not particularly limited, but is preferably a polymer soluble in DMF, and is more preferably a hydrophilic polymer in order to further increase the amount of water absorbed. Representative core polymers may include polyacrylonitrile, cellulose acetate, polyvinyl chloride, vinyl chloride-vinyl acetate copolymer or polyamide.

In the present invention, in order for the nanofibers comprising the copolymer to exist in a crosslinked form, crosslinking through a heat treatment is required.

In the case of the conventional thermoresponsive polymers, it is not possible to obtain a firm structure when nanofibers are prepared through electrospinning since the thermoresponsive polymers are vulnerable to water. For this reason, in the conventional preparing process, a measure in which the structure of nanofibers is strengthened by adding a crosslinking agent to the electrospinning solution and performing a heat treatment for a long time has been applied, but there has been a problem that the measure decreases the production efficiency.

However, since the nanofiber structure according to the present invention is copolymerized by containing an acrylic acid monomer, the hydrolysis reaction of acrylic acid may take place by a heat treatment at 150° C. to 200° C. and crosslinking may be thus achieved.

As the crosslinking agent, polymers such as acrylamide and hydroxymethylacrylamide may be used, but the crosslinking agent is not necessarily limited thereto.

The thermoresponsive nanofiber structure according to the present invention may have a lower critical solution temperature (LCST) of 33° C. to 38° C., and the lower critical solution temperature (LCST) may vary depending on the content of acrylic acid.

The nanofiber structure having a core-shell structure according to the present invention is a structure in which nanofibers are interconnected to one another, and thus has an advantage that the polymer constituting the shell part can facilitate the movement of water molecules and the hydrophilic polymer constituting the core part further maximize the amount of water absorbed.

The nanofiber structure according to the present invention has a high porosity and a high absorption rate as well as a mechanical strength of a certain level or higher, and can be thus applied to separation materials, drug delivery, energy storage, packaging, adsorption heat pumps, heat exchangers and the like.

### EXAMPLES

### Preparation of Thermoresponsive Copolymer

### Examples 1 to 3: Preparation of VCL+Acrylic Acid Copolymer

A VCL monomer and an AA monomer were mixed in an ethanol solvent at a 95:5, 90:10, or 80:20 mol % ratio, then the reaction solution was mixed with 0.5 mol % AIBN under a nitrogen atmosphere, and the mixture was maintained at 70° C. for 16 hours. After the reaction was completed, the product was washed with an excessive amount of nucleic acid and dried in a vacuum oven.

### Comparative Example 1: Preparation of PVCL Homopolymer

A VCL monomer was mixed in an ethanol solvent, then the reaction solution was mixed with 0.5 mol % AIBN under a nitrogen atmosphere, and the mixture was maintained at 70° C. for 16 hours. After the reaction was completed, the product was washed with an excessive amount of hexane and dried in a vacuum oven.

Experiment 1: Measurement of LCST Depending on Acrylic Acid Content

The lower critical solution temperature (LCST) was measured for Examples 1 to 3 and Comparative Example 1, and the results are summarized in [Table 1]. As can be seen from [Table 1], the LCST of the thermoresponsive copolymers according to the present invention is within the range of 34° C. to 38° C., the LCST varies depending on the acrylic acid content, and the LCST increases as the acrylic acid content increases.

TABLE 1

| | VCL:AA | | | | |
|---|---|---|---|---|---|
| | molar | Mixing ratio in | | M_{w} | |
| | ratio in | copolymer (mol %) | | (× 10\hat{ }4 | LCST |
| Sample | feed^{a} | VCL | AA | g/mol) | (° C.) |
| 95/5 copolymer | 95:5 | 94.75 | 5.25 | 10.9 | 34 |
| 90/10 | 90:10 | 89.5 | 10.5 | 12.2 | 35 |
| copolymer | | | | | |
| 82/20 | 82:20 | 79 | 21 | 12.4 | 38 |
| copolymer | | | | | |
| PVCL | 100:0 | 100 | 0 | 9.02 | 33 |
| homopolymer | | | | | |

(a; monomer concentration: 5 mmol/mL)

### Preparation of Nanofiber Structure

### Examples 4 to 7: (CS-1, 3, 5, and 10 Samples)

A spinning solution was prepared by dissolving the VCL/AA copolymer prepared in Example 2 (VCL:AA=90:10 mol % ratio) in DMF at 30 wt and used as a shell part spinning solution, and a spinning solution was prepared by dissolving PAN in DMF at 10 wt and used as a core part spinning solution. Thereafter, a core-shell nanofiber structure was prepared by performing co-axial electrospinning under the following electrospinning conditions: the applied voltage was 14 kV, a spinning distance of 20 cm was kept constant, and the ejection speed was differentiated as shown in FIG. 2.

### Example 8: (S-5 Sample)

A spinning solution was prepared by dissolving the VCL/AA copolymer prepared at a 90:10 mol % ratio in DMF at 30 wt %. Single-nozzle electrospinning was performed, and the electrospinning conditions were as follows: the applied voltage was 14 kV, a spinning distance of 20 cm was kept constant, and the ejection speed was 2 mL/h.

### Example 9: (Blend Sample)

A spinning solution in which the VCL/AA copolymer prepared at a 90:10 mol % ratio was dissolved in DMF at 30 wt % and a spinning solution in which PAN was dissolved in DMF at 10 wt % were mixed together at a ratio of 8:2 to prepare a spinning solution. Single-nozzle electrospinning was performed, and the electrospinning conditions were as follows: the applied voltage was 14 kV, a spinning distance of 20 cm was kept constant, and the ejection speed was 2 mL/h.

### Comparative Example 2: (PAN Sample)

A spinning solution was prepared by dissolving PAN in DMF at 10 wt %. Single-nozzle electrospinning was performed, and the electrospinning conditions were as follows: the applied voltage was 14 kV, a spinning distance of 20 cm was kept constant, and the ejection speed was 0.4 mL/h.

TABLE 2

| | | Ejection speed (ml/h) | | |
|---|---|---|---|---|
| | Electrospinning | Shell | Core | |
| Sample | method | solution | solution | Spinning solution |
| CS-1 | Co-axial | 0.4 | 0.4 | Core: 10 wt % PAN in |
| | electrospinning | | | DMF |
| CS-3 | Co-axial | 1.2 | 0.4 | Shell: 30 wt % 90/10 |
| | electrospinning | | | copolymer in DMF |
| CS-5 | Co-axial | 2.0 | 0.4 | |
| | electrospinning | | | |
| CS-10 | Co-axial | 4.0 | 0.4 | |
| | electrospinning | | | |
| S-5 | Single-nozzle | 2.0 | | 30 wt % 90/10 |
| | electrospinning | | | copolymer in DMF |
| Blend | Single-nozzle | 2.0 | | 80:20 blend of 30 |
| | electrospinning | | | wt % 90/10 |
| | | | | copolymer/10 wt % PAN |
| | | | | in DMF |
| PAN | Single-nozzle | | 0.4 | 10 wt % PAN in DMF |
| | electrospinning | | | |

(CS-# and S-#: # means the ratio of ejection speed between the shell solution and the core solution)

Experiment 2: Measurement of Change in Water Contact Angle of Nanofiber Structure Depending on Time

The water contact angles at the respective times were measured for Examples 4 to 9 and Comparative Example 2, and the results are illustrated in FIG. 3. According to FIG. 3, it can be seen that as the thickness of the shell part increases, water penetrates faster, and the change in water contact angle is larger in the case of core-shell nanofibers. In addition, it can be seen that the change in water contact angle is delayed by the water repelling phenomenon in the case of fibers containing PAN that is relatively less hydrophilic.

### Experiment 3: Measurement of Change in Water Contact Angle of Nanofiber Structure Depending on Temperature

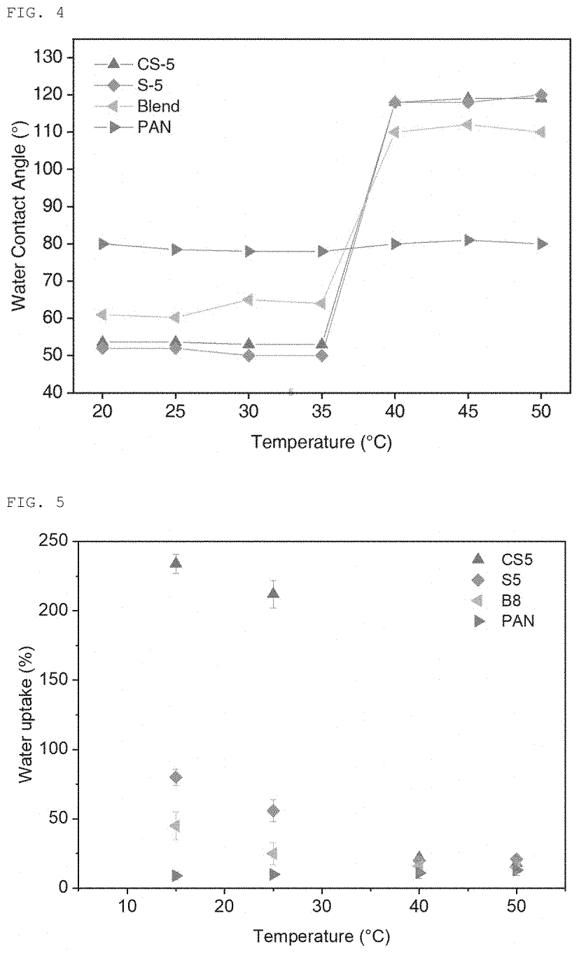

The water contact angles at the respective temperatures were measured for Example 6 (CS-5), Example 8 (S-5), Example 9 (Blend) and Comparative Example 2 (PAN), and the results are illustrated in FIG. 4. According to FIG. 4, it can be seen that the water contact angles of nanofiber structures (CS-5, S-5, Blend) containing a thermoresponsive polymer according to the present invention rapidly change from hydrophilic (water contact angle<90 degrees) to hydrophobic (water contact angle>90 degrees) at 35° C. to 40° C.

Experiment 4: Measurement of Change in Water Absorption Power of Nanofiber Structure Depending on Temperature

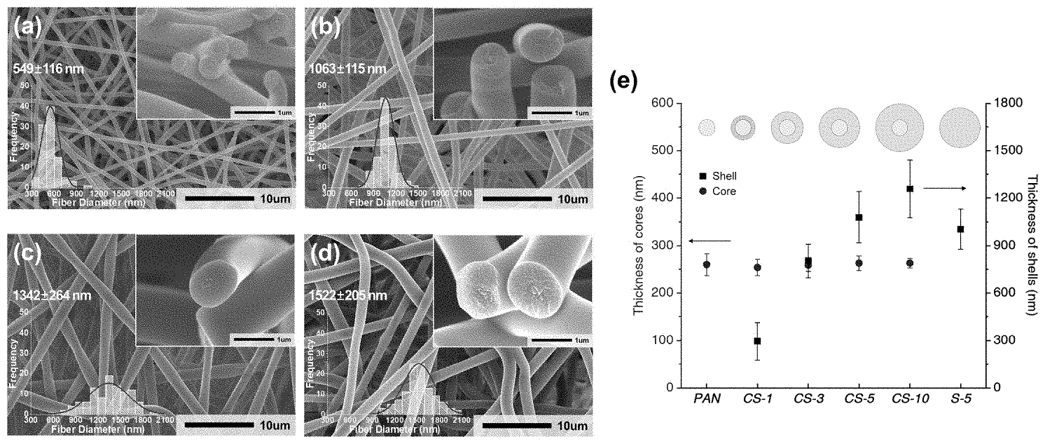

In order to measure the water absorption power of Example 6 (CS-5), Example 8 (S-5), Example 9 (Blend) and Comparative Example 2 (PAN) at the respective temperatures, each sample was exposed at different temperatures for 12 hours in a chamber maintained at a relative humidity of 95%. The results are as illustrated in FIG. 5, and it can be seen that the thermoresponsive polymer nanofibers according to the present invention exhibit thermoresponsivity. In particular, the nanofiber of Example 6 (CS-5) absorbs a significantly large amount of water (about 2341 at 20° C.) under a high humidity condition. On the other hand, it can be seen that the maximum water absorption power of the nanofiber of Comparative Example 2 (PAN) is only about 9% to 13% and the water absorption power does not greatly change depending on temperature.

Experiment 5: Measurement of Change in Shell Thickness Depending on Ejection Speed of Spinning Solution in Electrospinning

In order to confirm that the shell thickness of the nanofiber having a core-shell structure is different depending on the ejection speed of the spinning solution in co-axial electrospinning, the shell thicknesses of the nanofibers having a core-shell structure of Examples 4 to 8 and the nanofiber of Comparative Example 2 were measured, and the results are as illustrated in FIG. 6. It can be seen that the core diameter is about 260 nm since the ejection speed of the core solution is constant, and the shell thickness increases as the ejection speed of the shell solution increases.

The present invention as described above has been described with reference to the illustrated drawings, but it is apparent to those skilled in the art that the present invention is not limited to the described embodiments and can be variously changed and modified without departing from the spirit and scope of the present invention. Accordingly, it should be said that such variations or modifications belong to the claims of the present invention, and the scope of the present invention should be interpreted based on the appended claims.

1. A thermoresponsive copolymer comprising a repeating unit derived from a N-vinylcaprolactam monomer and a repeating unit derived from an acrylic acid monomer.

2. The thermoresponsive copolymer according to claim 1, wherein the copolymer comprises the repeating unit derived from a N-vinylcaprolactam monomer at 80 to 98 mol % and the repeating unit derived from an acrylic acid monomer at 2 to 20 mol %.

3. A nanofiber structure, wherein nanofibers comprising the copolymer according to claim 1 are crosslinked.

4. The nanofiber structure according to claim 3, wherein
the nanofiber has a core-shell structure,
a core of the nanofiber contains a hydrophilic polymer, and
a shell of the nanofiber contains the copolymer according to claim 1.

5. The nanofiber structure according to claim 4, wherein the hydrophilic polymer is one or more selected from the group consisting of polyacrylonitrile, cellulose acetate, polyvinyl chloride, vinyl chloride-vinyl acetate copolymer and polyamide.

6. The nanofiber structure according to claim 4, wherein the nanofiber structure has a lower critical solution temperature (LCST) of 33° C. to 38° C.

7. The nanofiber structure according to claim 4, wherein the nanofiber structure exhibits a water absorbing property at a temperature less than the LCST and a water desorbing property at a temperature more than the LCST.

8. A method for preparing a nanofiber structure, the method comprising:
preparing a copolymer by copolymerizing a N-vinylcaprolactam monomer and an acrylic acid monomer;
preparing nanofibers by electrospinning a copolymer spinning solution prepared by dissolving the prepared copolymer in an organic solvent; and
crosslinking the prepared nanofibers through a heat treatment.

9. The method for preparing a nanofiber structure according to claim 8, wherein the organic solvent is a protic solvent.

10. The method for preparing a nanofiber structure according to claim 8, wherein a hydrophilic polymer solution and the copolymer spinning solution are injected into an inner nozzle and an outer nozzle of a co-axial heterogeneous electrospinning device, respectively, and then electrospun to prepare nanofibers having a core-shell structure in the step of preparing nanofibers.
